(19) United States
(12) Patent Application Publication
(10) Pub. No.: US 2007/0273973 A1
(43) Pub. Date: Nov. 29, 2007

(54) Optical layer system having antireflection properties

(76) Inventors: Monika Kursawe, Seeheim-Jugenheim (DE); Edgar Boehm, Taipei (TW); Peter (Fangyun) Hsu, Taipei (TW)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/783,617

(22) Filed: Apr. 10, 2007

Related U.S. Application Data
(63) Continuation of application No. 10/903,584, filed on Aug. 2, 2004, now abandoned.

(30) Foreign Application Priority Data
Jan. 8, 2003 (DE) 103 36 041.7

(51) Int. Cl. G02B 1/10; B05D 5/00

(52) U.S. Cl. 359/584; 427/164; 427/165

(57) ABSTRACT

The invention relates to an optical layer system having antireflection properties, where a layer package comprising a first layer having a refractive index in the range from 1.20 to 1.37 and a second, smooth layer having a refractive index of from 1.40 to 1.48 is located on at least one surface of a transparent, planar substrate, to a process for the production thereof, and to the use thereof.

The present invention relates to optical layer systems having antireflection properties which comprise a plurality of layers on an optically transparent substrate and in particular can advantageously be employed in display devices, such as liquid-crystal displays for computer and television screens, or in touch-sensitive display devices, such as so-called touch panels or touch screens, but also for refractive index modification of transparent electrically conductive layers, for example for index-matched indium-tin oxide (IMITO) layers and for window panes, transparent glass and building parts, display cabinet glazing or optical lenses, to a process for the production thereof, and to the use thereof.

Optical layer systems on transparent substrates which are intended to increase the transmission of light through the substrates have been known for some time.

Thus, it is usual, for example, to apply a plurality of interference layers of alternating high and low refractive indices one on top of the other to a substrate. This results in virtually complete extinction of the reflected waves in a certain wavelength range.

Multiple layers of this type, which are described, for example, in H. K. Pulker, Coatings on glass, Thin films science and technology, 6 (1984), pages 401-405, are generally applied to the substrate via evaporation processes, such as sputtering, CVD (chemical vapour deposition) or PVD (physical vapour deposition). However, multilayered systems are also known in which the layers are applied by wet-chemical methods from solutions prepared via sol-gel processes.

Multilayered systems can only be produced with considerable effort and in addition have inherent mechanical stresses in the system which have to be compensated by means of special measures if a stress-free system is to be obtained. In addition, the transmission curves of multilayered systems generally have a more or less pronounced “V” or “W” shape. This results in a residual colour of the system, which is usually undesired. There is preferably a demand for antireflection coatings which have a transmission curve with uniformly high transmission over a broad wavelength range.

It is furthermore known to provide transparent substrates with a single coating in order to achieve an antireflection action. In this case, a so-called λ/4 layer is applied to the substrate, i.e. a layer having an optical thickness of λ/4 (λ=wavelength of the incident light), where the refractive index n of the antireflection layer should in the ideal case satisfy the condition
n=\sqrt{n(air)·n(substrate)}.

In this case, the amplitudes of the reflected wavelengths are cancelled. If, for example, low-iron glass having a refractive index of n=1.5 is employed, an optimum refractive index of 1.22 arises for the antireflection layer. In this case, the reflection of the electromagnetic radiation of wavelength λ adopts the value zero.

The single coatings used are principally MgF₂ layers produced via various vapour-deposition processes. A layer of this type applied in a thickness of λ/4 usually has a refractive index of 1.38. A residual reflection of significantly greater than 1% thus arises at the reflection minimum. A dense, durable material having a refractive index of less than 1.38 is not known.

Furthermore, porous durable layers which have a refractive index of less than 1.38 and are thus able to minimise the residual reflection of the coated substrate are now obtainable. Porous layers of this type can be obtained by etching of glass, application of a porous layer to glass or a combination of porous layer and etching process.

Porous layers having a degree of abrasion stability can be obtained, for example, using processes for the deposition of porous optical layers from metal-oxide sols, as described in DE 198 28 231 or in DE 100 51 725.

WO 00/10934 discloses a process for the production of a layer system having a porous antireflection layer in which a substrate provided with a porous layer is subsequently treated with a coating solution consisting of at least one metal-oxide sol and at least one tetra(C₁-C₄)alkyl orthosilicate in a weight ratio of from 1:1 to 9:1. This coating solution does not significantly impair the reflection values of the porous antireflection layer. The refractive index of the individual layers in this system is not disclosed. The protective layer applied subsequently, which is intended to improve the durability of the porous layer, has a rough surface due to the particle size of the applied sol of preferably 20 nm.

Abrasion-resistant SiO₂ antireflection layers having high light transmission can be obtained, according to WO 03/027015, through the use of a hybrid sol comprising [SiOₓ(OH)_{y}]ₙ particles, where 0<y<4 and 0<x<2, which comprise a mixture of one particle fraction having a particle size of 4-15 nm and a second particle fraction having a mean particle size of 20-60 nm in a water-containing solvent, where the hybrid sol is prepared in a special stepwise process. This enables the production of abrasion-resistant, optically transparent SiO₂ layers having refractive indices of between 1.20 and 1.40 on glass.

However, the use of porous antireflection layers of this type is, for example due to their rough surface, not possible without restrictions in all areas in which antireflection layers are to be used.

Antireflection properties in displays are very desirable in order to enable the user to have an unhindered view at any viewing angle.

Good antireflection properties are of particular importance in the touch-sensitive displays increasingly used in recent years, so-called touch screens or touch panels, which, due to their user-friendly mode of operation, are often used in car-park and travel ticket machines or in pocket computers or, for example, in information or customer terminals in banks and in other institutions often frequented by visitors.

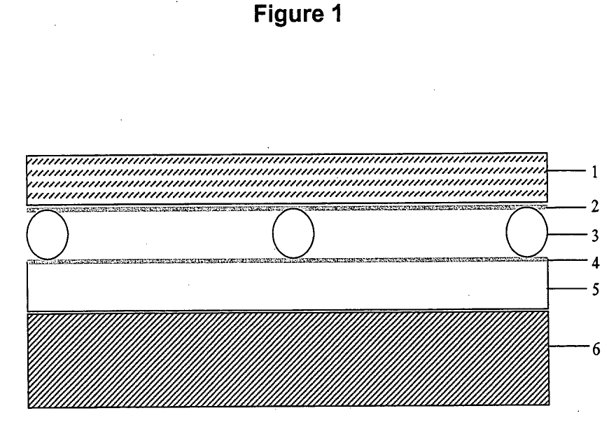

A diagrammatic structure of a touch panel is shown in FIG. 1. A touch panel is able to register digitally a mechanical pressure on a certain position of the screen. For this purpose, a stable, inflexible substrate (5), which usually consists of glass and has a transparent electrically conductive layer (4), is generally located on a liquid-crystal cell (6). This layer structure is connected via spacers (3) to a transparent, pressure-sensitive, flexible layer (1), usually a plastic film, which is likewise provided with a transparent, electrically conductive layer (2). The layers are arranged in such a way that the electrically conductive layers are only separated by the spacers. If a pressure is exerted at a point of the pressure-sensitive layer by means of a finger, stylus or the like, the conductive layers come into contact with one another. The position of this contact is determined via a voltage applied in one of the electrically conductive layers and the linear drop in voltage produced by the touch.

When light passes through the display glass, reflections occur at the surfaces of the glass plate due to the differences in the refractive indices of the different materials. These reflections are particularly interfering if the screen is viewed from flat angles.

There has been no lack of attempts to reduce these undesired reflections by the application of antireflection layers, which are either arranged between the inflexible support and the electrically conductive layer located thereon or between the flexible layer and the electrically conductive layer located thereon, or in both systems. The position of the antireflection layers within the system can also be varied here.

Thus, for example, U.S. Pat. No. 6.512,512 B1 describes a touch panel having improved optical properties which has an antireflection coating at each of the interfaces which come into contact with air within the multilayered structure of the panel. This coating consists of vapour-deposited layers of SiO₂ or MgF₂. However, owing to the refractive indices of 1.46 and 1.38 respectively which can be achieved with these materials, only unsatisfactory results with respect to the antireflection behaviour can be achieved therewith. In addition, at least one of these layers, which are located between the two conductive layers, must be provided with apertures via etching processes since otherwise no electrical contact would occur.

In WO 03/045865, a layer system comprising a glass plate and an electrically conductive layer is provided with antireflection properties by means of a multilayered coating comprising a titanium/praseodymium oxide layer, an MgF₂ layer, a further titanium/praseodymium oxide layer, an indium-tin oxide (ITO) layer and a further MgF₂ layer on the glass. This layer system is only obtainable via a very complex process, which is correspondingly expensive and makes high technical demands.

JP-A-08-195138 describes a touch panel which comprises transparent, conductive layers of indium-tin oxide which are coated on either one or both sides with antireflection layers having a refractive index of from 1.2 to 1.5 and a layer thickness of from 0.2 to 0.8 μm. This layer system is located either on the flexible substrate or the inflexible substrate and may also be present on both. With the aid of this layer structure, the aim is to prevent the formation of Newton's rings, in particular in the case of curved substrates.

JP-A-07-257945 discloses a touch panel in which a transparent, electrically conductive layer is provided on one or both sides with an antireflection layer which has a refractive index of ≦1.6. With SiO₂ layers applied to both sides in a thickness of 1100 Ångstrom and having a refractive index of 1.46, a light transparency of 95.1% at a wavelength of 550 nm can thus be obtained in one example.

For high-quality touch panels, in particular in combination with the newly developed high-resolution colour flat panel displays, a light transparency, increased by antireflection layers, of at least 2 and preferably 3% per glass interface is necessary on use of glass substrates. In the case of the usual double-sided coating of the glass substrate, which generally has a transparency of 92%, this results in a requirement with respect to the transparency of at least 96% (integrated and weighted over the visible region of the spectrum). The porous layers employed in the antireflection coating of glass substrates cannot readily be applied to the layer system present in touch panels, which comprises a substrate and an electrically conductive, transparent layer, since the optical properties of the electrically conductive layer must also be taken into account. In addition, porous layers consisting of the SiO₂ usually employed are not lye-resistant, which can result in problems in the usual process for the production of touch panels. A further disadvantage of porous layers is that, when they are applied in the immediate vicinity of an electrically conductive transparent layer, they have an adverse effect on the electrical conductivity and thus the electrical layer resistance of this layer due to their rough surface as a consequence of production. This can result in transmission errors during determination of the position of a signal.

The object of the present invention is therefore to provide an optical layer system having antireflection properties on a planar, transparent substrate, which system also achieves excellent transmission values in the case of a transparent, electrically conductive layer additionally to be applied to the substrate, has a smooth surface, which, in combination with a transparent, electrically conductive layer located thereon, results in a uniform layer resistance therein, is acid- and alkali-resistant and mechanically stable, consists of the lowest possible number of layers and can be produced inexpensively via a simple process.

The object of the invention is achieved by means of an optical layer system having antireflection properties which comprises a transparent, planar substrate having two surfaces essentially parallel to one another and has on at least one of these surfaces a layer package comprising
a first layer having a refractive index in the range from 1.20 to 1.37 on the substrate surface and
a second, smooth layer having a refractive index of from 1.40 to 1.48 on the first layer.

The object of the invention is furthermore achieved by a process for the production of an optical layer system in which
a) a planar substrate having two surfaces essentially parallel to one another is coated on at least one of the surfaces with a layer having a refractive index in the range from 1.20 to 1.37 and
b) this layer is coated with a smooth layer having a refractive index in the range from 1.40 to 1.48.

The object of the invention is moreover achieved by the use of the optical layer system described above for the production of antireflection-coated glasses and plastics for window panes, transparent building and vehicle parts, display cabinet glazing, optical lenses, displays, touch-sensitive displays and for refractive-index-modified, transparent, electrically conductive layers.

The invention furthermore relates to antireflection-coated glasses and plastics for window panes, transparent building and vehicle parts, display cabinet glazing, optical lenses, displays, touch-sensitive displays and refractive-index-modified, transparent, electrically conductive layers which comprise the optical layer systems described above.

The optical layer system according to the invention consists of a transparent, planar substrate having two surfaces essentially parallel to one another and has on at least one of these surfaces a layer package comprising a first layer having a refractive index in the range from 1.20 to 1.37 on the substrate surface and a second, smooth layer having a refractive index of from 1.40 to 1.48 on the first layer.

Suitable substrates for the optical layer system in accordance with the present invention are all known planar substrates which are transparent in a broad range, in particular in the visible range, of the solar spectrum, which are generally used for the production of optical layer systems.

These planar substrates have two surfaces essentially parallel to one another, i.e. they are layer-form materials, such as panes, plates, sheets and the like which have an essentially uniform thickness. The planar substrate here may be deformed or curved as such.

The substrates for the optical layer system in accordance with the present invention are flexible or inflexible, i.e. rigid or pliable, but have a layer thickness which facilitates a rigidity which is adequate for common coating processes.

In particular, the substrates consist of flexible or inflexible glass or flexible or inflexible plastic. The glass materials employed are, in particular, borosilicate glass, soda-lime glass, quartz glass and preferably so-called float glass. Plastics which can be employed are, for example, polyethylene terephthalate (PET), polyesters (for example MYLAR D® from Dupont), polycarbonates (for example G.E. LEXAN®) or polyethylene.

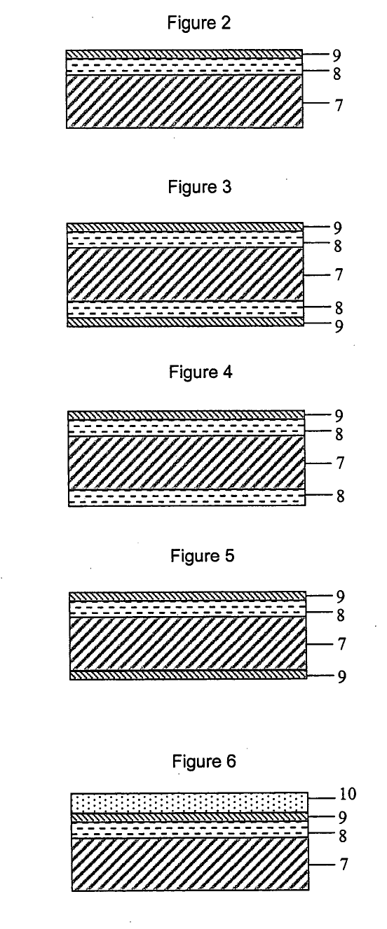

The simplest embodiment of the invention is depicted in FIG. 2. On at least one surface of the substrate (7) is located a layer package comprising a first layer having a refractive index in the range from 1.20 to 1.37 (8) directly on the surface of the substrate and a second, smooth layer having a refractive index in the range from 1.40 to 1.48 (9) on the first layer. This layer package may optionally also be located on both surfaces of the planar substrate. This embodiment is depicted in FIG. 3. Identical numerals here in each case denote layers of the same type. These have the properties described, but may also be composed of different materials. However, it is likewise possible for the above-mentioned layer package comprising layers (8) and (9) to be present on only one surface of the planar substrate, while only part of the layer package, i.e. only one layer having a refractive index in the range from 1.20 to 1.37 (8) directly on the surface of the substrate or alternatively a smooth layer having a refractive index in the range from 1.40 to 1.48 (9) directly on the surface of the substrate, is located on the opposite surface of the substrate. These embodiments are depicted in FIGS. 4 and 5.

Further layers may also be applied to the optical layer systems described above, these being, in particular, additionally applied, transparent, electrically conductive layers.

These transparent, electrically conductive layers are known per se and comprise materials, such as indium oxide (10), indium-tin oxide (ITO), antimony-doped tin oxide (ATO), fluorine-doped tin oxide (FTO), zinc oxide (ZO), indium-doped zinc oxide (IZO), cadmium stannate (CTO), aluminum-doped zinc oxide (Al:ZnO), or mixtures thereof. The electrically conductive layer particularly preferably comprises indium-tin oxide (ITO).

In a further embodiment, which is shown in FIG. 6, a transparent, electrically conductive layer (10) is located directly on the upper layer of the layer system described above, namely on the smooth layer having a refractive index in the range from 1.40 to 1.48 (9).

It is advantageous here for the layer package comprising the layers described above having a refractive index in the range from 1.20 to 1.37 (8) and a refractive index in the range from 1.40 to 1.48 (9) additionally to be located on the opposite substrate surface (see FIG. 7).

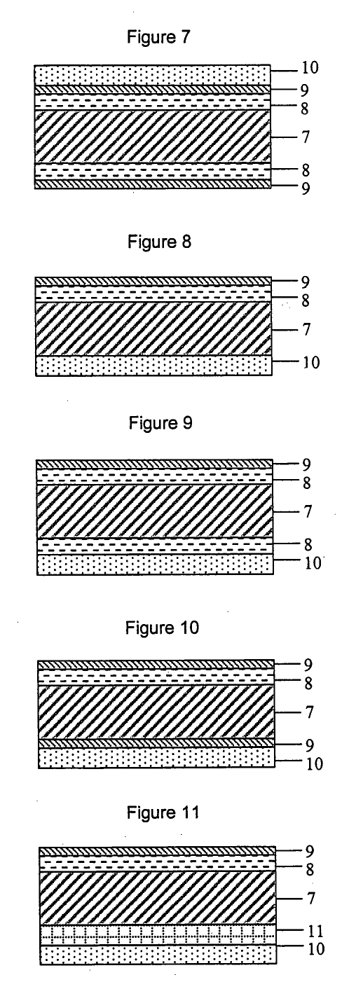

However, an embodiment is also possible in which a layer package comprising a first layer having a refractive index in the range from 1.20 to 1.37 (8) directly on the surface of the substrate and a second, smooth layer having a refractive index in the range from 1.40 to 1.48 (9) on the first layer is located on one surface of the planar substrate (7), while a transparent, electrically conductive layer (10), which may likewise be composed of the materials mentioned above, is present on the opposite surface. This embodiment is depicted in FIG. 8.

Two additional embodiments (see FIGS. 9 and 10) are composed of a planar substrate (7) which has on one surface a layer package comprising a first layer having a refractive index in the range from 1.20 to 1.37 (8) directly on the surface of the substrate and a second, smooth layer having a refractive index in the range from 1.40 to 1.48 (9) on the first layer, while either a layer having a refractive index in the range from 1.20 to 1.37 (8) or a smooth layer having a refractive index in the range from 1.40 to 1.48 (9) and a transparent, electrically conductive layer (10) applied thereto are located on the opposite surface of the substrate. Preference is given here to the variant in which a smooth layer having a refractive index in the range from 1.40 to 1.48 (9) and a transparent, electrically conductive layer (10) applied thereto are located on the second substrate surface.

In a further preferred embodiment, the layer package comprising a first layer having a refractive index in the range from 1.20 to 1.37 (8) and a second, smooth layer having a refractive index in the range from 1.40 to 1.48 (9) is located on one surface of the planar substrate (7), while a multilayered antireflection layer system (11) comprising alternating layers of high (n≧1.8) and low (n<1.8) refractive index is applied to the opposite surface of the substrate.

It is particularly advantageous for a transparent, electrically conductive coating (10) comprising the materials described above to be located on this multilayered antireflection layer. This particularly preferred embodiment is depicted in FIG. 11.

Multilayered antireflection layer systems (11) of this type are sufficiently known from the prior art.

The materials of high refractive index employed are, in particular, dielectric materials, such as TiO₂, ZrO₂, SnO₂, SiO, In₂O₃, Nb₂O₅, oxides of the rare-earth metals and mixed oxides of these with the materials mentioned above, and the materials of low refractive index employed are dielectric materials, such as SiO₂, Al₂O₃ or mixed oxides thereof with oxides of the rare-earth metals, or MgF₂.

The above-described embodiments of the invention may, depending on the type of their use, also be provided with further layers or alternatively used in combination with other layer systems. The materials for the further layers and layer systems here are limited only inasmuch as they must not impair the reflection-reducing properties of the optical layer system according to the invention.

In accordance with the present invention, the optical layer system comprises a first layer having a refractive index in the range from 1.20 to 1.37 on at least one side of a transparent, planar substrate.

In particular, this layer has a refractive index in the range from 1.22 to 1.30. The layer is present on the substrate in a thickness of preferably from 50 to 130 nm, in particular from 70 to 90 nm.

A suitable material for this layer is any material with which the stated refractive-index range can be set.

In particular, a suitable material for this layer is SiO₂. In order to be able to obtain a refractive index in the stated range, the SiO₂ is preferably present in a porous layer. A porous layer having a refractive index in the range from 1.20 to 1.37 can be obtained, for example, in a simple manner if it is produced from a hybrid sol as described in WO 03/027015. A hybrid sol as described in WO 03/027015, the entire contents of which are incorporated herein by way of reference, is therefore a preferred starting material for the production of a porous SiO₂ layer having a refractive index in the range from 1.20 to 1.37.

If the layer having a refractive index in the range from 1.20 to 1.37 consists of a porous SiO₂ layer, it has a rough surface and generally has fine cracks.

The optical layer system according to the invention additionally comprises a second, smooth layer having a refractive index in the range from 1.40 to 1.48 on the surface of the first layer having a refractive index of from 1.20 to 1.37.

This second layer preferably has a refractive index in the range from 1.40 to 1.46.

The layer thickness of the smooth layer is preferably from 5 to 30 nm and particularly preferably from 10 to 20 nm.

The material for this layer is not limited. Any material with which the stated refractive-index range can be set can in principle be used. However, preference is given to the use of SiO₂.

An SiO₂ layer having a refractive index of from 1.40 to 1.48 has significantly lower porosity than an SiO₂ layer having a refractive index of from 1.20 to 1.37 and has a smooth surface without cracks and essentially without interfering unevenness.

If, in a particularly preferred embodiment, both the first layer having a refractive index in the range from 1.20 to 1.37 and the second, smooth layer having a refractive index in the range from 1.40 to 1.48 consist of SiO₂, it has been found, surprisingly, that the pores and cracks present on the surface of the first, relatively thick layer are not, in spite of material identity, translated to the second, smooth layer of significantly lower thickness. This second, smooth layer thus provides the optical layer system as a whole with a smooth surface which significantly simplifies the application of subsequent thin, homogeneous and smooth layers. In particular, it has been found that a transparent, electrically conductive layer comprising the materials mentioned above applied to the second, smooth layer can be applied so smoothly that it has, in its application, for example in touch panels, a uniform, stable electrical layer resistance which could not be achieved in a comparative experiment with only one porous SiO₂ layer on a transparent, planar substrate on which the transparent, conductive layer is directly located. The requirements of the optical layer system, including an additionally applied, transparent, electrically conductive layer, namely to achieve, in the case of the use of glass substrates, an increase in transparency of more than 2 and preferably more than 3% per glass interface, can likewise be satisfied with the optical layer system according to the invention. At the same time, adequate resistance in acids and lyes is observed. In addition, the optical layer system according to the invention can be produced in a simple manner.

In accordance with the invention, the optical layer system described above is produced by a process which comprises the following steps:
a) coating of a transparent, planar substrate having two surfaces essentially parallel to one another with a layer having a refractive index in the range from 1.20 to 1.37 and
b) coating of this layer with a smooth layer having a refractive index in the range from 1.40 to 1.48
   on at least one of the surfaces of the substrate.

Suitable substrates are the substrates already described above. Preference is given to the use of flexible or inflexible glass as substrate. However, the flexible or inflexible plastic substrates likewise described can also be used.

The transparent, planar substrates are provided either on only one or alternatively on both surfaces with a coating in accordance with process steps a) and b).

However, it is also possible to carry out process steps a) and b) on one of the surfaces, while only step a) or step b) is carried out on the opposite surface. It is advantageous here for process steps a) and/or b) to be carried out simultaneously on both surfaces. A transparent, electrically conductive layer is preferably also subsequently applied to at least one of the layers applied in step b). For the case where the transparent, planar substrate has been coated onto one of the surfaces by means of process steps a) and b), but onto the other surface merely by means of process step a), the coating obtained via process step a) can also be provided with a transparent, electrically conductive layer.

In a further embodiment, the two layers in accordance with process steps a) and b) are applied to one of the surfaces of the planar, transparent substrate, while either a transparent, electrically conductive layer or a conventional multilayered antireflection layer system comprising alternating layers of high (n≧1.8) and low (n<1.8) refractive index is applied to the opposite substrate surface.

In the case of coating of the substrate surface opposite the layer package with a conventional multilayered antireflection layer system, the latter is preferably additionally also coated with a transparent, electrically conductive layer.

The materials employed for this purpose correspond here to the layer materials already mentioned above for transparent, electrically conductive layers and for high- and low-refractive-index layers.

In this case, the transparent, electrically conductive layer or the multilayered antireflection layer system is advantageously applied by evaporation techniques known from the prior art, such as sputtering, CVD, PVD, electron-beam evaporation, ion plating and the like.

However, the multilayered antireflection layer system can also be applied to the substrate via a spin-coating process, a roller-coating process, a printing process or the like, with the individual layer materials being prepared via a wet-chemical process, such as, for example, a sol-gel process. In this case, however, additional measures must be taken to protect the opposite surface of the substrate against contamination by the liquid layer materials.

It goes without saying that any desired further layers, selected depending on the application of the optical layer system according to the invention, can also be applied to each surface of the planar substrate coated as described above.

Preference is given to an embodiment of the present invention in which the planar substrate is coated on at least one of its surfaces with a layer package in accordance with process steps a) and b) and subsequently with a transparent, electrically conductive layer, the latter very preferably comprising indium-tin oxide.

In a further, particularly preferred embodiment, the planar substrate is coated on one of its surfaces with a layer package in accordance with process steps a) and b) and on the opposite surface with a conventional multilayered antireflection layer system comprising the materials mentioned above and subsequently with a transparent, electrically conductive layer on the antireflection layer system, the electrically conductive layer very preferably comprising indium-tin oxide.

In accordance with the invention, at least one surface of a transparent, planar substrate is coated with a layer having a refractive index in the range from 1.20 to 1.37, preferably from 1.22 to 1.30, in process step a).

Since refractive indices in the range from 1.20 to 1.37 are virtually impossible to obtain with dense single layers comprising common coating materials, a porous layer, preferably consisting of SiO₂, is preferably applied in process step a).

The production of porous SiO₂ layers of this type is known.

Thus, for example, the sols described in DE 198 28 231 or in DE 100 51 725 can be used as starting substances for coating the substrate with a layer having a refractive index in the range from 1.20 to 1.37.

As already described above, however, a hybrid sol which is described in detail in WO 03/027015 is preferably employed for the production of the first layer according to the invention in accordance with process step a). This hybrid sol, which comprises [SiOₓ(OH)_{y}]ₙ particles, where 0<y<4 and 0<x<2, which comprise a mixture of one particle fraction having a particle size of 4-15 nm and a second particle fraction having a mean particle size of 20-60 nm in a water-containing solvent, is prepared by hydrolytic polycondensation of tetraalkoxysilanes in an aqueous, solvent-containing medium, giving silicon oxide hydroxide particles having a particle size of 4-15 nm, with addition of a monodisperse silicon hydroxide sol having a mean particle size of from 20 to 60 nm and a standard deviation of at most 20% at a certain point in time after commencement of the hydrolytic polycondensation.

Application of this hybrid sol to glass enables the production of a substantially abrasion-stable, optically transparent SiO₂ layer having a refractive index in the range from 1.20 to 1.40 in a simple manner.

Coating solutions of this type obtained wet-chemically from sol-gel processes are applied to the prepared substrates, i.e. substrates which have been cleaned, optionally pretreated by conventional methods and dried. Suitable processes for application of the layers here are known processes, such as dip coating, spin-coating processes, roller-coating processes, printing processes, such as, for example, screen-printing processes, flow-coating processes, such as, for example, curtain coating, or so-called meniscus coating.

As the simplest of these processes, dip coating is advantageously employed. This is particularly suitable as coating process if both surfaces of the substrate are to be coated simultaneously with a layer in accordance with process step a). However, if particular measures are taken to protect the second layer, for example by the joining of two substrates, it is also possible to coat only a single surface of a substrate by a dip-coating process.

Depending on the desired layer thickness, it is necessary here to match the viscosity of the coating solution and the parameters of the coating process, such as, for example, the dipping and drawing rate of the substrates to be coated, to one another. Thus, the usual drawing rates in dipping processes are generally between 0.5 and 70 cm/min.

All other application processes described above are suitable both for application of liquid layers in accordance with process step a) on one side and on both sides.

After application of a porous layer of this type, this is, if necessary, optionally dried and/or cured. The layer must be cured here in such a way that sintering is avoided. The usual curing temperatures are therefore below about 550° C. for the conventional porous SiO₂ coatings, since the sintering process usually commences above this temperature. Porous SiO₂ layers produced from the hybrid sol described above can, under certain conditions, also be subjected to temperatures of above 700° C. without sintering in the process.

After the optional drying and/or curing of the first layer having a refractive index in the range from 1.20 to 1.37 on the substrate, this is coated with a second layer in accordance with process step b).

However, the application of a porous SiO₂ layer can also be carried out via an etching process.

Here, a phase can be dissolved out of the matrix from, for example, glasses having a phase separation in the matrix using an etchant, as described in U.S. Pat. No. 4,019,884.

However, it is also possible, as disclosed, for example, in U.S. Pat. No. 4,535,026, for a liquid coating solution to be obtained by means of a wet-chemical process, applied to a substrate by means of the known processes described above, such as dip coating, etc., and for a porous layer subsequently to be produced via an etching process.

It is likewise possible for SiO₂ layers to be applied to a substrate via known evaporation processes, such as, for example, sputtering, CVD or PVD, and subsequently, if desired, likewise etched in order to produce higher porosity.

After the etching operation, the substrates coated in this way are post-treated in the conventional manner, i.e. optionally washed and/or dried. A coating can subsequently be carried out in accordance with process step b) of the present invention.

The application of the layer having a refractive index in the range from 1.20 to 1.37 in accordance with process step a) is preferably carried out via the processes described above by means of a coating solution prepared in a wet-chemical sol-gel process.

The dry and optionally cured layer preferably has a dry layer thickness of from 50 to 130 nm and in particular from 70 to 90 nm.

As second layer, a layer having a refractive index in the range from 1.40 to 1.48, preferably from 1.40 to 1.46, is applied to the coating applied in step a).

This layer is smooth and has on its surface neither cracks nor interfering unevenness. In addition, it has substantially lower porosity than the first layer applied in process step a).

The second layer applied in process step b) is preferably produced from SiO₂.

A coating material consisting of metallic silicon, SiO, SiO₂ or organosilicon compounds is preferably applied here to the first layer by means of an evaporation process known from the prior art, such as, for example, a sputtering process, a CVD process or a PVD process or the like. The SiO₂ layer produced in this way is smooth and has a refractive index in the range from 1.40 to 1.48 and in particular from 1.40 to 1.46.

However, this second layer can also be obtained by densifying the first layer applied in step a). This process is preferably carried out if both the first layer and the second layer on the substrate consist of the same material and in particular both layers consist of SiO₂.

The densifying of the first porous SiO₂ layer here is carried out via the application of a silane-containing coating solution to the surface of this SiO₂ layer. The application here can be carried out via the processes already described above, such as dip coating, spin coating, roller coating, printing, curtain coating, meniscus coating or the like. The silane-containing coating solution penetrates into the pores and cracks on the surface of the first layer and fills them. At the same time, the entire surface is covered with a very thin layer of the coating solution, which, after drying, has no pores and/or cracks.

The silane-containing coating solution employed here is preferably a mixture of ethyl orthosilicate and solvent which comprises water and is stabilised by means of acid. The SiO₂ oligomers present in this coating solution generally have a small mean particle size. This is advantageously in the range from about 2 to about 10 nm and is in particular about 5 nm.

On densifying of the surface of the porous first layer, a smooth layer having a refractive index in the range from 1.40 to 1.48 and in particular from 1.40 to 1.46 is likewise obtained on its surface.

Irrespective of the type of coating process in process step b), the dry layer thickness of the second layer is set in such a way that it is preferably in the range from 5 to 30 nm and in particular in the range from 10 to 20 nm. If this layer is obtained via densifying of the first porous layer, its layer thickness must be observed during application of the first layer inasmuch as a dry layer thickness increased by the penetration depth of the silane-containing layer may have to be applied there.

After application of the silane-containing coating solution to the surface of the first, porous layer, the resultant coating is optionally dried and/or cured.

The optical layer system according to the invention can subsequently be coated with further layers depending on need and area of application. Thus, it is particularly advantageous for a transparent, electrically conductive layer comprising the materials already described above to be applied to the upper, smooth layer. Due to the smooth surface of the optical layer system according to the invention, the subsequent layer can also be applied with a uniform layer thickness. In addition, it has full-area contact with the underlying upper layer of the optical layer system according to the invention. This results in a stable electrical layer resistance of the transparent, electrically conductive layer, which proves particularly advantageous, in particular on use in touch panels. In the case of application of the layer package to both surfaces of a glass substrate and subsequent coating of one of the surfaces with a transparent, electrically conductive layer, the requisite transmission values of the layer system as a whole, including the electrically conductive layer, of at least 96% (integrated and weighted over the entire visible spectrum) can also be achieved. In addition, the optical layer system in accordance with the present invention behaves like a single-layer system with respect to its transmission curve. Thus, the transmission is uniformly high over a broad wavelength range and there is no pronounced “V” or “W” shape of the transmission curve.

For this reason, the optical layer systems according to the invention are highly suitable for use in state-of-the-art display systems, in particular for touch-sensitive displays and very particularly for touch panels in combination with high-resolution colour flat panel displays.

However, the optical layer system in accordance with the present invention can likewise advantageously be used for the production of antireflection coatings on glasses and plastics for window panes, transparent building and vehicle parts, display cabinet glazing, optical lenses, displays in general and for the production of refractive-index-modified, transparent, electrically conductive layers, in particular for the production of so-called index-matched ITO (IMITO) layers.

FIG. 1 shows a diagrammatic representation of a conventional touch-sensitive display (touch panel) without the optical layer system according to the invention having antireflection properties.

FIGS. 2 to 11 depict various embodiments of the present invention.

The following examples are intended to explain the present invention without restricting it thereto.

### EXAMPLE 1

A float-glass sheet measuring 350×400 mm and having a thickness of 1.8 mm is cleaned firstly with an aqueous cerium oxide slurry and subsequently with an alkaline detergent. A hybrid-sol coating solution as described in WO 03/027015 having a content of 0.9% by weight of SiO₂ is applied to both sides of the substrate by means of a dip-coating process at a drawing rate of about 20 cm/min. The resultant layer is cured for 10 minutes in a fan-assisted oven at 550° C. The layer formed is porous and has a dry layer thickness of about 100 nm. The glass substrate coated in this way is cleaned in a glass-washing machine and subsequently coated on both sides with an SiO₂ layer in a layer thickness of 15 nm each via a sputtering process. An indium-tin oxide layer having a thickness of 10 nm is subsequently also sputtered onto one of the substrate surfaces.

### EXAMPLE 2

A float-glass sheet measuring 350×400 mm and having a thickness of 1.8 mm is cleaned with an alkaline detergent at 95° C. A hybrid-sol coating solution as described in WO 03/027015 having a content of 1.6% by weight of SiO₂ is applied to both sides of the substrate by means of a dip-coating process at a drawing rate of about 7 cm/min. The resultant layer is cured for 10 minutes in a fan-assisted oven at 550° C. The layer formed is porous and has a dry layer thickness of about 70 nm. The substrate coated in this way is subsequently subjected to a second dipping operation. The second coating solution is composed of a solution of tetraethyl orthosilicate, ethanol, n-butanol, n-butyl acetate, nitric acid and water mixed with 2-propanol. The drawing rate is 4 cm/min. The coating is dried for 10 minutes at 100° C. and cured for 60 minutes at 500° C. in a fan-assisted oven. One side of the substrate coated in this way is coated with an indium-tin oxide layer having a thickness of 9 nm via an evaporation process. This layer is subjected to heat treatment at 400° C. for 60 minutes.

### EXAMPLE 3

A float-glass sheet measuring 350×400 mm and having a thickness of 1.8 mm is cleaned with an alkaline detergent at 95° C. In each case, two of these cleaned sheets are bonded closely to one another over the entire area. The sheets are coated with a hybrid sol analogously to Example 1. The sheets are separated and cured for 10 minutes at 550° C. in a fan-assisted oven. A porous SiO₂ layer having a dry layer thickness of about 100 nm is obtained on one side of each of the glass substrates. An SiO₂ layer having a thickness of 15 nm is sputtered onto each of these porous layers. The uncoated side of the glass substrate is in each case coated with an indium-tin oxide layer having a thickness of 9 nm by means of an evaporation process. This layer is subjected to heat treatment at 400° C. for 60 minutes.

### EXAMPLE 4

A float-glass sheet measuring 350×400 mm and having a thickness of 1.8 mm is cleaned with an alkaline detergent in a standard horizontal glass-washing machine line. An SiO₂-containing hybrid-sol coating solution as described in WO 03/027015 is applied to one side of the cleaned float-glass sheet by means of a spin-off-coating process. The resultant layer is subsequently cured in the upright position in a belt furnace at a maximum furnace temperature of 650° C. The layer formed is porous and has a dry layer thickness of about 70 nm. The glass substrate coated in this way is subsequently coated on the pre-coated side with an SiO₂ layer in a layer thickness of 20 nm via a sputtering process. The uncoated side of the glass substrate is coated with a total of 4 alternating layers of Nb₂O₅ and SiO₂ by means of a sputtering process and generally usual layer thicknesses for a 4-layer antireflection coating. This 4-layer system is subsequently coated with an indium-tin oxide layer having a thickness of 15 nm with the aid of a sputtering process.

### EXAMPLE 5

A float-glass sheet having the same dimensions as in Example 1 is firstly coated on one side with two SiO₂ layers using a process according to Example 4, and subsequently, instead of a 4-layer system, an SiO₂ layer having a thickness of 15 nm is sputtered onto the uncoated side of the glass substrate. This is subsequently coated with an indium-tin oxide layer having a thickness of 15 nm analogously to Example 4 with the aid of a sputtering process.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosure of all applications, patents and publications, cited herein and of corresponding German application No. 10336041.7, filed Aug. 1, 2003 is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Optical layer system having antireflection properties, comprising a transparent, planar substrate having two surfaces essentially parallel to one another which has on at least one of these surfaces a layer package comprising
a first layer having a refractive index in the range from 1.20 to 1.37 on the substrate surface and
a second, smooth layer having a refractive index of from 1.40 to 1.48 on the first layer.

2. Optical layer system according to claim 1, where the layer package is present on both surfaces of the substrate.

3. Optical layer system according to claim 1, where one surface of the substrate has the layer package, and a layer having a refractive index in the range from 1.20 to 1.37 or a smooth layer having a refractive index of from 1.40 to 1.48 is located on the second substrate surface.

4. Optical layer system according to claim 1, where one surface of the substrate has the layer package, and an electrically conductive layer is located on the second substrate surface.

5. Optical layer system according to claim 1, where at least one surface of the substrate has the layer package, and an electrically conductive layer is located on at least one of the upper, smooth layers of the layer package.

6. Optical layer system according to claim 1, where one surface of the substrate has the layer package, and a multilayered antireflection layer system comprising alternating layers of high (n≧1.8) and low (n<1.8) refractive index is located on the second substrate surface.

7. Optical layer system according to claim 6, where an electrically conductive layer is additionally located on the multilayered antireflection layer system.

8. Optical layer system according to claim 6, where the layers of high refractive index are composed of TiO₂, ZrO₂, SnO₂, SiO, In₂O₃, Nb₂O₅, oxides of the rare-earth metals and mixed oxides thereof with the above-mentioned oxides, and the layers of low refractive index are composed of SiO₂, Al₂O₃, mixed oxides thereof with oxides of the rare-earth metals, or MgF₂.

9. Optical layer system according to claim 3, where an electrically conductive layer is located on the layer package, on the smooth layer having a refractive index of from 1.40 to 1.48 or on the layer having a refractive index in the range from 1.20 to 1.37.

10. Optical layer system according to claim 4, where the electrically conductive layer is transparent and comprises indium-tin oxide, indium oxide, antimony-doped tin oxide, fluorine-doped tin oxide, zinc oxide, indium-doped zinc oxide, cadmium stannate, aluminium-doped zinc oxide or mixtures thereof.

11. Optical layer system according to claim 1, where the transparent, planar substrate consists of flexible or inflexible glass or a flexible or inflexible plastic.

12. Optical layer system according to claim 1, where the layer having a refractive index in the range from 1.20 to 1.37 has a layer thickness of 50-130 nm.

13. Optical layer system according to claim 1, where the smooth layer having a refractive index in the range from 1.40 to 1.48 has a layer thickness of 5-30 nm.

14. Optical layer system according to claim 1, where the layer having a refractive index in the range from 1.20 to 1.37 consists of SiO₂.

15. Optical layer system according to claim 1, where the smooth layer having a refractive index in the range from 1.40 to 1.48 consists of SiO₂.

16. Optical layer system according to claim 1, where the layer having a refractive index in the range from 1.20 to 1.37 is porous.

17. Optical layer system according to claim 1, where the smooth layer having a refractive index in the range from 1.40 to 1.48 has lower porosity than the layer having a refractive index in the range from 1.20 to 1.37.

18. Process for the production of an optical layer system according to claim 1, comprising the steps of
a) coating of a transparent, planar substrate having two surfaces essentially parallel to one another with a layer having a refractive index in the range from 1.20 to 1.37 and
b) coating of this layer with a smooth layer having a refractive index in the range from 1.40 to 1.48
on at least one of the surfaces of the substrate.

19. Process according to claim 18, where an SiO₂ layer is applied in step a).

20. Process according to claim 18, where an SiO₂ layer is applied in step b).

21. Process according to claim 18, where the layer having a refractive index of from 1.20 to 1.37 is porous and is applied by a dip-coating process, spin-coating process, roller-coating process, printing process or flow-coating process and is optionally dried and/or cured before the coating in accordance with step b).

22. Process according to claim 18, where the layer having a refractive index of from 1.20 to 1.37 is porous and is applied by means of a dip-coating process, spin-coating process, roller-coating process, printing process or flow-coating process or by means of an evaporation process and is subsequently etched and then coated in accordance with step b).

23. Process according to claim 18, where the layer having a refractive index in the range from 1.40 to 1.48 has lower porosity than the layer from a) and is applied by means of a sputtering process, a CVD process or a PVD process.

24. Process according to claim 18, where the layer having a refractive index in the range from 1.40 to 1.48 has lower porosity than the layer from a) and is produced by densifying of the surface of the layer from a).

25. Process according to claim 24, where the densifying is carried out by application of a silane-containing layer to the surface of the porous layer and optionally subsequent drying and/or curing.

26. Process according to claim 18, where both surfaces of the substrate are coated in accordance with steps a) and b).

27. Process according to claim 26, where both surfaces of the substrate are each coated simultaneously in accordance with steps a) and b).

28. Process according to claim 18, where one surface of the substrate is coated in accordance with steps a) and b), and the second surface is coated in accordance with step a) or b).

29. Process according to one claim 18, where one surface of the substrate is coated in accordance with steps a) and b), and the second surface is coated with an electrically conductive layer or a multilayered antireflection layer system comprising alternating layers of high (n≧1.8) and low (n<1.8) refractive index.

30. Process according to claim 28, where an electrically conductive layer is additionally applied to the layer applied to the second surface in step a) or step b) or to the multilayered antireflection layer system.

31. Process according to claim 18, where at least one surface of the substrate is coated in accordance with steps a) and b), and an electrically conductive layer is applied to the upper, smooth layer.

32. Process according to claim 29, where the electrically conductive layer applied is a transparent layer of indium-tin oxide, indium oxide, antimony-doped tin oxide, fluorine-doped tin oxide, zinc oxide, indium-doped zinc oxide, cadmium stannate, aluminium-doped zinc oxide or mixtures thereof.

33. Process according to claim 18, where the substrate is a flexible or inflexible glass or a flexible or inflexible plastic.

34. Process according to claim 18, where the layer applied in step a) has a dry layer thickness of 50-130 nm.

35. Process according to claim 18, where the layer applied in step b) has a dry layer thickness of 5-30 nm.

36. Use of the optical layer systems according to claim 1 for the production of antireflection-coated glasses and plastics for window panes, transparent building and vehicle parts, display cabinet glazing, optical lenses, displays, touch-sensitive displays and for refractive-index-modified, transparent, electrically conductive layers.

37. Use according to claim 36 in touch panels and for index-matched ITO layers (IMITO).

38. Antireflection-coated glasses and plastics for window panes, transparent building and vehicle parts, display cabinet glazing, optical lenses, displays, touch-sensitive displays and refractive-index-modified, transparent, electrically conductive layers, comprising an optical layer system according to claim 1.

39. Antireflection-coated glasses and plastics according to claim 38 for touch panels and index-matched ITO layers (IMITO).
